(19) United States
(12) Patent Application Publication
(10) Pub. No.: US 2017/0161902 A1
(43) Pub. Date: Jun. 8, 2017

(54) SYSTEM FOR DETECTING VEHICLE FUEL DOOR STATUS

(71) Applicant: Dura Operating, LLC, Auburn Hills, MI (US)

(72) Inventors: Rajashekhar Patil, Ypsilanti, MI (US); Gordon M. Thomas, Beverly Hills, MI (US)

(21) Appl. No.: 14/956,568

(22) Filed: Dec. 2, 2015

(51) Int. Cl. G06T 7/00; H04N 7/18; G06K 9/00; B60Q 9/00

(52) U.S. Cl. CPC G06T 7/0044; B60Q 9/00; H04N 7/183; G06K 9/00791; G06T 2207/30252

(57) ABSTRACT

A system to detect a vehicle fuel door alert condition and a method using the system is described. The system includes an optical sensor having a field of view (FOV) which includes a vehicle fuel door region, the optical sensor providing an output including image data from the fuel door region; and a controller in communication with the optical sensor to receive the output, the controller including at least one processor adapted to analyze the optical sensor output and provide an alert output at least when the optical sensor output is indicative that a fuel door in the vehicle fuel door region is at least partially open.

### TECHNICAL FIELD

The present disclosure relates to a vehicle optical sensing system for detecting a vehicle fuel door status, and more particularly, it relates to the system to determine an open or closed state of the fuel door.

### BACKGROUND

Pressure sensors in a vehicle fuel tank may be used to determine that the fuel tank pressure is lower than a normal pressure. This low pressure scenario sometimes occurs due to the vehicle fuel cap not be secured to a vehicle fuel fill passage.

### SUMMARY

At least some implementations of a system to detect a vehicle fuel door alert condition are described. The system includes an optical sensor and a controller. The optical sensor may have a field of view (FOV) that includes a vehicle fuel door region, and the optical sensor may provide an output that includes image data associated with the fuel door region. The controller is in communication with the optical sensor to receive the output and may include at least one processor adapted to analyze the optical sensor output and provide a control output at least when the optical sensor output indicates that the vehicle fuel door is at least partially open.

In at least some implementations, a system to detect a vehicle fuel door alert condition includes an optical sensor and a controller. The optical sensor is adapted to monitor an area of a vehicle that includes a vehicle fuel door region. The controller is couplable to the optical sensor, and includes memory and at least one processor. The memory is a non-transitory computer readable medium having instructions stored thereon for determining the vehicle fuel door alert condition. The instructions include receiving an image from the optical sensor that includes a region of interest that includes the fuel door region, analyzing the image using image processing techniques to determine at least one criteria associated with the alert condition, and when at least one criteria is determined, then providing the alert signal.

Further, at least some implementations of a method of detecting a vehicle fuel door alert condition using a controller in a vehicle are described. The method includes: receiving at the controller at least one image from an optical sensor, wherein the at least one image comprises a region of interest associated with a vehicle fuel door region; using at least one image, determining at the controller whether the vehicle fuel door alert condition exists, wherein the alert condition is associated with a fuel door in the vehicle fuel door region being at least partially open; and when the alert condition is determined to exist, then providing an alert signal from the controller.

Other embodiments can be derived from combinations of the above and from the embodiments shown in the drawings and the descriptions that follow.

### BRIEF DESCRIPTION OF THE DRAWINGS

The following detailed description of preferred implementations and best mode will be set forth with regard to the accompanying drawings, in which:

FIG. 1 is a schematic view of a vehicle having an optical sensing system, the vehicle being positioned on a vehicle camera calibration pad;

FIG. 2 is a perspective view of a fuel door region of the vehicle shown in FIG. 1 and a filling station nozzle;

FIG. 3 is a perspective view of an area on a driver's side of the vehicle shown in FIG. 1, from the point of view of a camera mounted in a driver's side mirror of the vehicle;

FIG. 4 is an enlarged perspective view of a fuel door region of the vehicle shown in FIG. 3 having the filling station nozzle in a fuel port and a fuel cap dangling from a tether; and

FIGS. 5A-5B are flow diagrams illustrating a method of determining a fuel door status.

### DETAILED DESCRIPTION

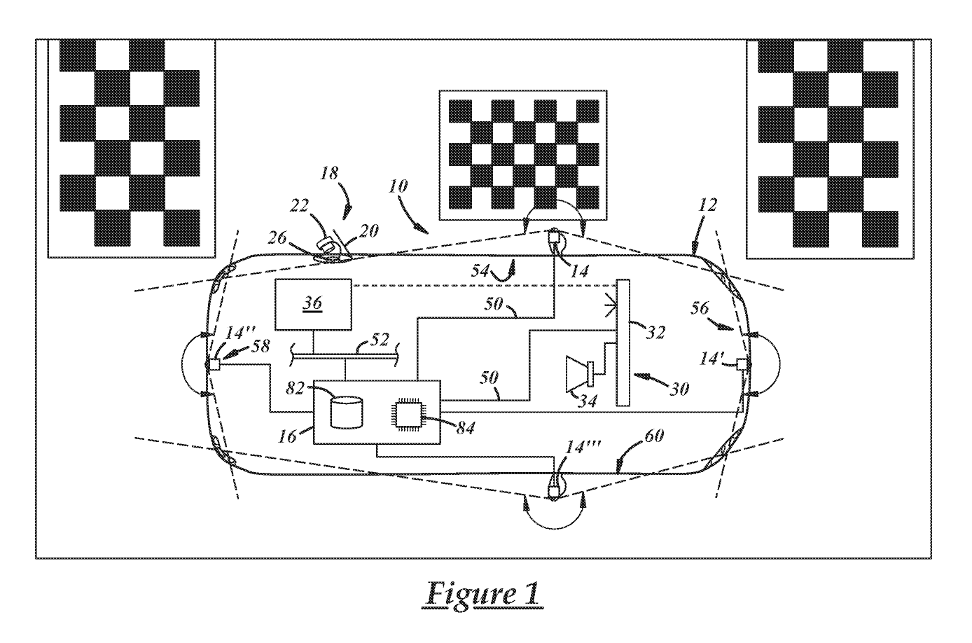

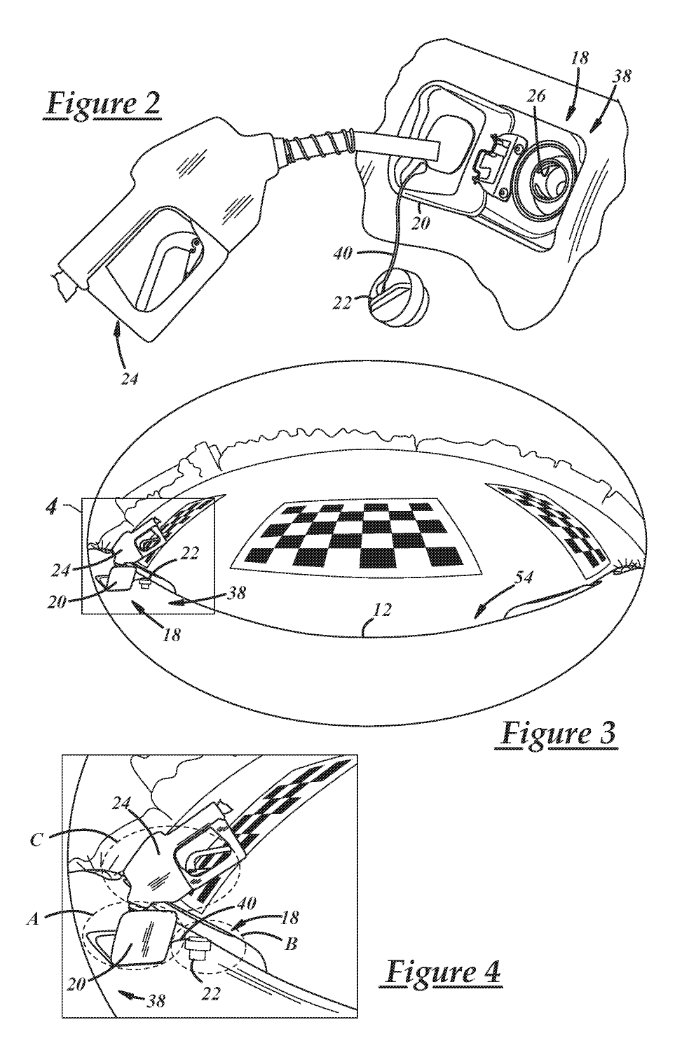

Referring in more detail to the drawings, FIG. 1 illustrates an embodiment of an optical sensing system 10 for a vehicle 12 that comprises at least one optical sensor or detector, such as a camera 14, and an electronic control unit (ECU) or controller 16 in communication with the camera(s). The sensing system 10 may be integrated with or embedded in the vehicle 12 as original equipment and may assist in providing a variety of functions including monitoring a fuel door region 18 and determining a fuel door status—e.g., whether a fuel door alert condition exists. For example, an alert condition may include determining that a fuel door 20 is open, determining that a fuel cap 22 is dangling, or determining that a fuel station filling nozzle 24 is received in a fuel port 26 of the vehicle 12 (e.g., prior to the vehicle driving away from the filling station); see FIGS. 1 and 2. In determining the fuel door status, the ECU 16 may monitor the fuel door region 18 by receiving image data from the camera 14 and using image processing techniques. As will be described more below, when the ECU 16 determines a fuel door alert condition, the ECU 16 accordingly may provide an output signal (e.g., an alert or control signal) to warn or alert a vehicle user (e.g., a vehicle driver or passenger).

As shown in FIG. 1, the vehicle 12 is depicted in the illustrated embodiment as a passenger car, but it should be appreciated that any other vehicle including trucks, sports utility vehicles (SUVs), recreational vehicles (RVs), marine vessels, aircraft, etc., can also be used. Vehicle 12 may include the fuel door region 18 (which includes the fuel door 20, the fuel cap 22, and the fuel port 26), a variety of other vehicle electronics 30 (e.g., including an instrument panel 32, an audio system 34, and one or more vehicle control modules (VCMs) 36 (only one is shown)), and the optical sensing system 10. The vehicle 12 is shown located on a vehicle camera calibration pad (e.g., a portion of which is shown) to better illustrate the point of view of camera 14, which point of view is illustrated in FIG. 3 and explained in greater detail below.

The vehicle fuel door 20 may be coupled to the vehicle 12 in any suitable manner. As best shown in FIG. 2, the fuel door 20 may be hinged to a body or body panel 38 of the vehicle 12. This is merely illustrative and other suitable couplings are contemplated. The fuel cap 22 may comprise threads or other retention members to couple cap 22 to an opening of the fuel port 26 which ultimately communicates with the vehicle's fuel tank (not shown). Thus, the fuel cap 22 may be engaged with the fuel port 26 by rotation and disengaged via counter-rotation. In at least some instances, when the fuel cap 22 is not engaged to port 26, it will be appreciated that it may hang or dangle (e.g., by a tether 40). Although not required, typically the tether 40 is long enough to allow the cap 22 to dangle below the fuel door 20, as illustrated.

As shown in FIG. 1, other vehicle electronics 30 include the instrumental panel 32 and/or audio system 34 which may be adapted to provide visual alerts, audible alerts, tactile alerts, or a combination thereof to the vehicle user. Non-limiting examples of visual alerts include an illuminated icon on the instrument panel 32, a textual message displayed on the instrument panel 32, an alert on a vehicle user's mobile device (not shown), and the like. Non-limiting examples of audible alerts include rings, tones, or even recorded or simulated human speech. Non-limiting examples of tactile alerts include a seat or steering wheel vibration. In at least one implementation, the alert may be triggered by the ECU 16—e.g., when the ECU determines a fuel door alert condition, as will be explained in greater detail below. Thus, the ECU 16 may communicate with the instrument panel 32 and audio system 34 via one or more discrete connections 50 (wired or wireless); however, a direct connection is not required. Or for example, these vehicle electronics 30 could be coupled indirectly to ECU 16—e.g., ECU 16 could be coupled to a vehicle control module 36 which in turn is coupled to the instrumental panel 32.

Vehicle electronics 30 also may comprise one or more VCMs 36 configured to perform various vehicle tasks. One non-limiting example of a vehicle task includes monitoring a fuel tank pressure and providing a ‘check engine’ warning via the instrument panel 32 when a fuel tank pressure is determined to be below a threshold. VCM 36 also could provide an informational message or signal to the ECU 16, which may be used in the method described below—e.g., since a low pressure indication could result from the fuel cap 22 not being properly secured to the port 26. Generally, skilled artisans will appreciate that a ‘check engine’ warning light is an ambiguous indicator; i.e., it does not indicate a source or root cause of a problem, only that a problem exists. Further, even if the user were provided a less ambiguous indication—e.g., that a low fuel tank pressure exists—this would not indicate a root cause either (e.g., which may be simply that the fuel cap 22 is not secured). This of course is merely an example of a task of the VCM 36 and an example of how VCM data may be used by the ECU 16 in some implementations; other implementations are contemplated also.

One or more VCMs 36 may be coupled to the ECU 16 via a vehicle communication bus 52. Or in other implementations, discrete electrical connections could be used or any other suitable type of communication link (e.g., optical links, short range wireless links, etc.).

Referring again to FIG. 1, ECU 16 of the optical sensing system 10 may include or be associated with memory 82 and one or more processors 84. Memory 82 includes any non-transitory computer usable or computer readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes. In at least one embodiment, ECU memory 82 includes an EEPROM device or a flash memory device.

Processor(s) 84 can be any type of device capable of processing electronic instructions including microprocessors, microcontrollers, electronic control circuits comprising integrated or discrete components, application specific integrated circuits (ASICs), and the like. The processor(s) 84 can be a dedicated processor(s)—used only for ECU 16—or it can be shared with other vehicle systems (e.g., VCMs 36). Processor(s) 84 execute various types of digitally-stored instructions, such as software or firmware programs which may be stored in memory 82, which enable the ECU 16 to provide a variety of vehicle services. For instance, processor(s) 84 can execute programs, process data and/or instructions, and thereby carry out at least part of the method discussed herein. In at least one embodiment, processor(s) 84 may be configured in hardware, software, or both: to receive image data from camera 14; to evaluate the image data using an image processing algorithm; and to determine whether a fuel door alert conditions exists. When an alert condition is detected, the processor(s) 84 also may generate an alert signal that may be used by the instrument panel 32 and/or audio system 34 to notify the vehicle user of an abnormal fuel door status, as will be explained in greater detail below.

In at least one embodiment, the processor 84 executes an image processing algorithm stored on memory 82. The algorithm may use any suitable image processing techniques, including but not limited to: pixelation, linear filtering, principal components analysis, independent component analysis, hidden Markov models, anisotropic diffusion, partial differential equations, self-organizing maps, neural networks, wavelets, etc.—as those terms are understood by skilled artisans. The algorithm may be used to identify regions of interest in an image or image data, compare real-time image data to stored image data, and use one or more image processing techniques such as edge detection to determine the fuel door status, as will be discussed in greater detail below.

As used herein, stored image data or stored images include images which include pattern information regarding a region of interest. Thus, the stored image could include an entire frame of image data from camera 14 (e.g., which would include the ground and environment, as well as part of vehicle 12—inlcuding the fuel door region 18). However, this is not required. For example, the stored image could include a portion of the image—e.g., only pattern data of the region of interest. This could be a pixel pattern representative of a fuel door—e.g., in a closed state or in an open state. The pattern could include shape, relative size, contrasting features, etc. Thus, the term stored image data or stored image should be construed broadly.

As used herein, real-time image data and real-time images are data which is received from camera 14 in actual time, in near actual time, during the current ignition cycle, or even during the current ignition cycle and including a predetermined period of time prior to the ignition cycle. For example, in one embodiment, real-time image data or images include those images received by the camera 14 and transmitted to the ECU 16 (e.g., actual time less any processing delays at the camera 14 and/or ECU 16 and less any transmission lag time). In another embodiment, the real-time image data or images include any images received by camera 14 within a predetermined period of time from when the image data or image was first captured by camera 14. And in other embodiments, real-time image data or images could include a predetermined period of time prior to a vehicle ignition event (e.g., provided the camera 14 is powered and operative during this time period).

The optical sensing system 10 may be operable with a single camera 14; however, as will be explained below, in at least one embodiment, the system 10 comprises multiple cameras. Camera 14 may be positioned to capture image data that includes the fuel door region 18. For example, when the fuel door is on the driver's side of the vehicle, the camera 14 may be mounted at a driver side region 54 of the vehicle 12 (e.g., on or around a driver's side mirror or any other suitable feature on the driver side of the vehicle 12). Characteristics or parameters of camera 14 include a horizontal field of view (HFOV) of approximately 180° (e.g., using a fisheye lens). In at least one embodiment, the HFOV of camera 14 may be approximately 185°; however, this is not required and in other implementations, the HFOV could be larger or smaller. The vertical field of view (VFOV) may be narrower and may accommodate any suitable aspect ratio (e.g., 4:3, 16:9, etc.). It should be appreciated that the terms HFOV and VFOV are relative terms; thus, depending upon the orientation of camera 14 when mounted in the vehicle 12, the HFOV may not be horizontal with respect to the actual horizon and the VFOV may not be vertical with respect thereto. However, in at least one implementation, the HFOV of camera 14 is horizontal with respect to the actual horizon (see FIG. 3, which is discussed below). The camera 14 may have any suitable refresh rate (e.g., 30 Hz, 60 Hz, 120 Hz, just to name a few examples). Its depths of field (or effective focus ranges) may be suitable for detecting or resolving features on the vehicle 12, roadway objects, or even other nearby vehicles (e.g., between 0 meters to infinity).

In at least one implementation, camera 14 may be digital and may provide digital image data to the ECU 16; however, this is not required (e.g., analog images or video could be processed by ECU 16 instead). Camera 14 may be configured for day and/or low-light conditions; e.g., in digital camera implementations, an imaging sensor having a pixel array (not shown) of camera 14 could be adapted to process visible light, near-infrared light, or any combination thereof making camera 14 operable in day- or night-time conditions. Other optical sensor or camera implementations are also possible (e.g., sensors capable of thermal imaging, infrared imaging, image intensifying, etc.). In FIG. 1, camera 14 is shown coupled directly to the ECU 16 via a discrete connection 50. However, in other implementations, camera 14 may be coupled using a communication bus (e.g., bus 52) or the like.

FIG. 3 illustrates an image captured by camera 14. The image may be a single image directly from the camera or a stitched or otherwise merged combination of more than one image. The image may be discretely captured by camera 14 and, in at least one embodiment, camera 14 is a video camera with a frame rate of 10 frames/second or greater and the image is one frame of the video image data. For example, FIG. 3 illustrates an image of the driver side region 54 of vehicle 12 and the ground nearby, a portion of which includes a region of interest (namely, the fuel port region 18). As used herein, a region of interest is at least a portion of an image, or a set or subset of data within an image that pertains to the vehicle fuel door region 18 (e.g., at least a portion of the entire video frame).

FIG. 1 also illustrates an embodiment having three other cameras 14′, 14″, 14′″, each of which may be identical to camera 14. Again, only one camera is required; however, here cameras 14, 14′, 14″, 14′″ are respectively located in the driver side region 54 (as described above), a front region 56 of the vehicle 12 (e.g., in the vehicle grill, hood, or front bumper), a rear region 58 of the vehicle 12 (e.g., on a vehicle rear door, trunk, rear bumper, tailgate, etc.), and a passenger side region 60 (e.g., on or around a passenger's side mirror or any other suitable feature on the passenger side of the vehicle 12). In one embodiment, the primary use or purpose of the system 10 (including cameras 14, 14′, 14″, 14′″) is not to monitor the fuel door region 18, but instead to provide advanced driver assistance services (e.g., to generate lane departure warnings, generate blind spot detection/warnings, and the like). Thus, cameras 14, 14′, 14″, 14′″ could be arranged to enable a view of a significant portion of the vehicle 12 or environment surrounding the vehicle, up to and including a vehicle user surround-view or a 360° view around the vehicle 12. Regardless of the quantity of cameras or their arrangement, it has been discovered that the cameras 14, 14′, 14″, 14′″ can be used for secondary purposes as well—e.g., camera 14 can be used to assist to detecting one or more fuel door alert conditions, as described above. Other secondary purposes with cameras 14, 14′, 14″, 14′″ are also possible.

Further, while the vehicle 12 in FIG. 1 has the fuel door region 18 positioned on the driver side region 54, this is not required. For example, system 10 could have a fuel door region on the passenger side region 60 and instead utilize a camera mounted in the passenger side mirror. Similarly, if the fuel door was in the rear region 58 (or front region 56), a proximate camera could carry out the method described below.

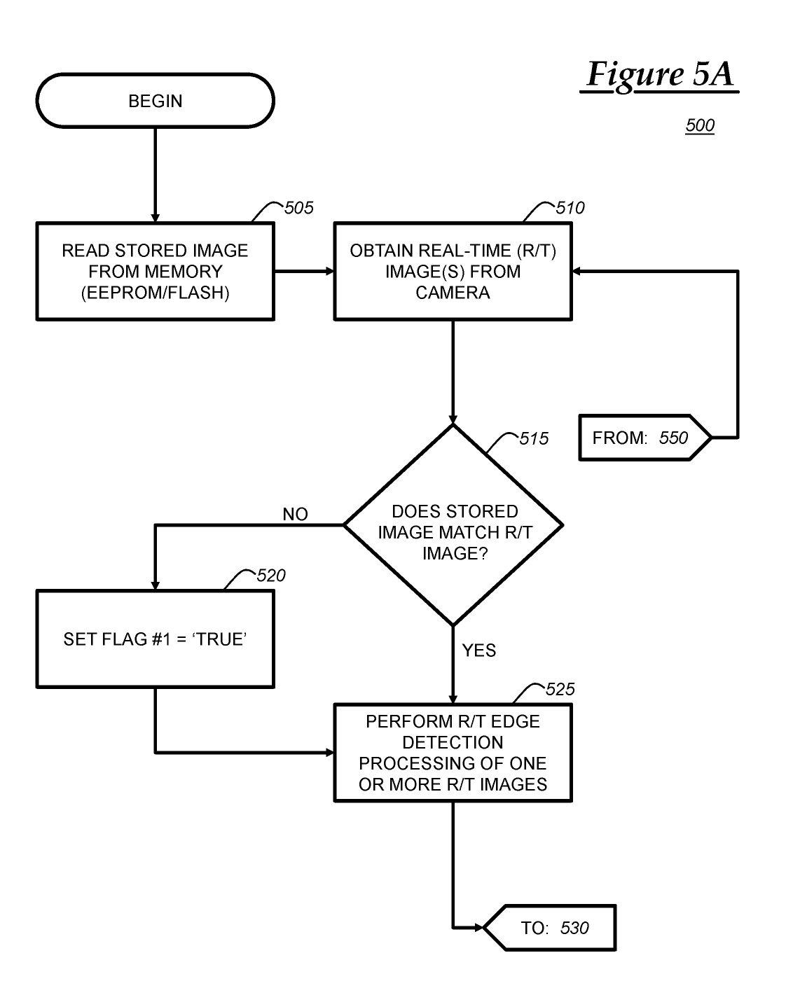

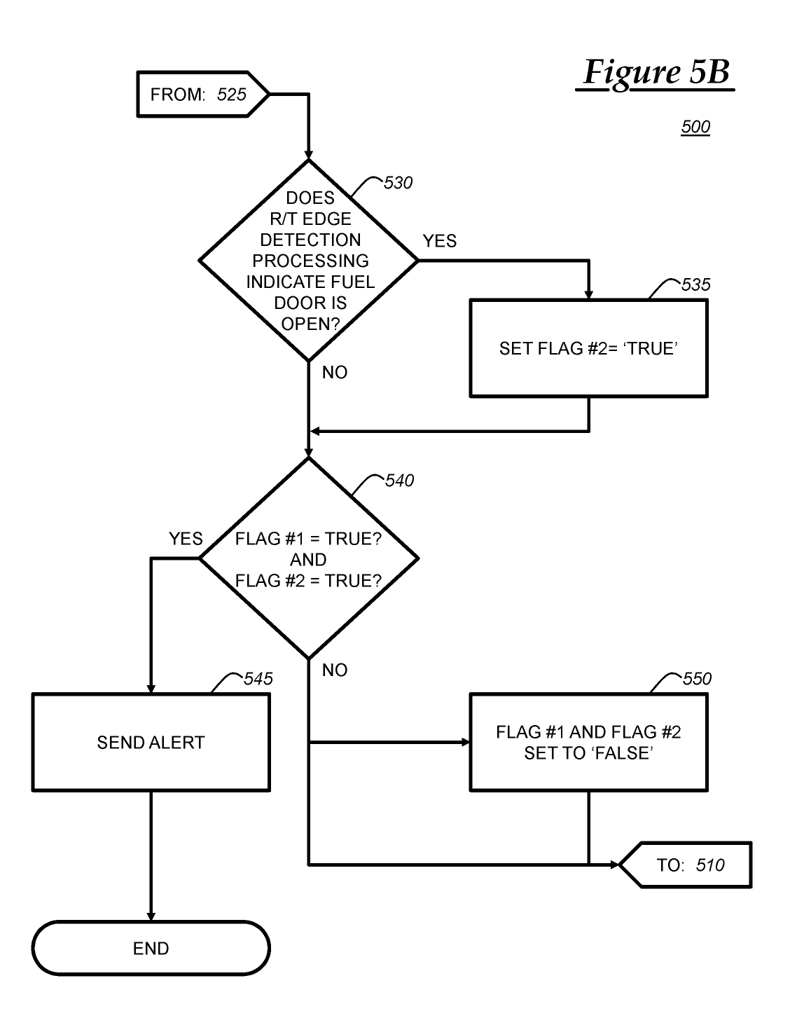

Turning now to FIGS. 5A and 5B, a method 500 is shown using the optical sensing system 10 to detect or determine a fuel door status—e.g., to detect or determine an existence of a fuel door alert condition. As will be explained in greater detail below, the method may be used to alert the vehicle user of one or more of these alert conditions. In some implementations, a detection of a single criteria suggesting an alert condition warrants sending a prompt notification to the vehicle driver—e.g., when the system 10 determines that the filling station nozzle 24 remains in the fuel port 26 (and the ECU 16 detects that the vehicle is about to pull away from the filling station). To illustrate, processor 84 using imaging processing software in the ECU 16 may determine a first criteria (e.g., an object is located proximate to and outboard of the fuel door 20; however, the object may not necessarily be identified as a fuel nozzle 24). Detection of this first criteria may sufficient to trigger an alert signal from the ECU 16. And in other implementations, multiple criteria may be required before an alert condition is determined (or confirmed) and before an alert signal is sent from the ECU 16. For example, the processor 84 may determine that the fuel door 20 appears open by comparing real-time image(s) to one or more stored images (first criteria), and the processor 84 also may detect ‘an edge’ within the fuel door region of interest indicative of an open fuel door 20 (the second criteria), e.g., using an edge detection algorithm. Upon detecting two or more such criteria, the processor 84 may determine or confirm an alert condition and then send the alert signal from the ECU 16 to the instrument panel 32. In this latter instance, it may be desirable to acquire a greater certainty of the alert condition to avoid false positive alerts (e.g., more than one criteria may be required to determine that the fuel door is open or that the fuel cap 22 is dangling). These again are merely examples; other criteria and implementations using the criteria are possible, as explained in the method(s) below.

The method 500 may begin with step 505 at any suitable time once the system 10 is powered (e.g., any time following vehicle ignition or power up). In at least one embodiment, the method 500 may be initiated only when the vehicle 12 is stationary (e.g., when the vehicle transmission is in PARK); however, this is not required. In at least one embodiment, the ECU 16 may receive an informational message indicating a transmission shift to PARK (e.g., from one of the VCMs 36).

In step 505, the processor 84 of ECU 16 calls up or retrieves one or more images stored in memory 82 which comprise at least the region of interest—i.e., the fuel door region 18. FIGS. 5A-5B are described with respect to the fuel door 20; however, as will be explained below, other embodiments of method 500 may include detection of the fuel cap 22 dangling or the nozzle 24 in the fuel port 26 and are explained below. Each of the stored image(s) may be captured (e.g., at the manufacturer) using camera 14—e.g., when the camera 14 is positioned at a vehicle side mirror, at least a portion of the body panel 38, as well as the fuel door region 18, may be viewable using its wide field of view. In one embodiment, one or more images are retrieved of the fuel door 20 in a closed state. Where multiple images are stored of the fuel door 20 in the closed state, these images may differ in various ways or manners. For example, the images may portray the fuel door 20 in the closed state in various ambient lighting conditions or the fuel door 20 (and/or body panel 38) may have different colors or shades of color (or different grayscale shades). As discussed below, in other embodiments, one or more images may be retrieved from memory 82 wherein the fuel door 20 may be in various open states (e.g., fully open, partially open, etc.). Either of these embodiments may be used singly or in combination with one another.

Next in step 510, the processor 84 of the ECU 16 may receive one or more real-time (R/T) images from the camera 14. In at least one embodiment, the portion of the body panel 38 captured in the real-time image(s) may be identical or nearly so to the portion of the body panel 38 captured in the stored images (of step 505)—e.g., since the position and orientation of camera 14 may be fixed. As will be described below, since the stored and real-time image(s) will be compared to one another, this may simplify some image processing aspects—e.g., since the relative position of the region of interest (the fuel door region 18) may be the same in both the stored and the real-time images. Step 510 further may include at least temporarily storing these real-time image(s) in memory 82 (e.g., during image processing by processor 84).

In step 515 which follows, processor 84 of the ECU 16 may analyze and/or compare the one or more stored images (step 505) to the one or more real-time images (obtained step 510). In at least one embodiment, the analysis and/or comparison is of a specific region of interest (A)—the fuel door 20 (see also FIG. 4). And in at least one embodiment, the processor 84 attempts to match the stored image of a closed fuel door 20 to the one or more real-time images received in step 510. In one embodiment, this may include pattern recognition techniques, pixel-for-pixel comparison between stored image(s) and real-time image(s), or the like. As used herein, pattern recognition techniques include shape and size recognition and/or identification. When the processor 84 fails to determine a match (i.e., no stored image of a closed fuel door 20 matches any of the one or more real-time images), the method 500 may proceed to step 520 and thereafter to step 525. Alternatively, when the processor 84 determines a match (i.e., that at least one stored image matches at least one real-time image), then the method directly proceeds to step 525.

As used herein, a match may include fuel door features (captured in the stored image) being identical to corresponding fuel door features (captured in the real-time image). Thus, a match could include a pixel-for-pixel comparison between the stored and real-time images. In some embodiments, a match may be determined without each pixel from the stored image being the identical to the corresponding pixel of the real-time image. For example, a match may be determined when a sufficient threshold quantity of pixels can be correlated between the two images. Further, such correlations may take into account a number of image processing factors such as image luminance differences, environmental noise or distortion differences, etc. Correlating stored and real-time images which constitute a match when every corresponding pixel is not identical will be appreciated by artisans familiar with pattern recognition and other image processing techniques.

Steps 505, 510, and 515 have been discussed with respect to stored image(s) of the fuel door region 18, wherein the fuel door 20 shown in the stored image was in the closed state; however, other comparison techniques also could be used. For example, the stored image(s) could portray the fuel door 20 in an open state (e.g., in various states of being partially open, or fully open), and the real-time image(s) could be compared to these stored image(s). In this instance, if one of the real-time images matches one of the stored images, then processor 84 determines a match of an open state of the fuel door 20 and the method 500 proceeds to step 520. Likewise, in this instance, if no match of the open state is determined, then the method could proceed directly to step 525. This technique could be used singly or in combination with techniques of closed state detection described above.

In step 520, the processor 84 may set a first counter or first flag to a value indicating that an indicia or criteria that the fuel door 20 is at least partially open (FLAG #1=‘true’). Again, in some embodiments, it may be desirable to establish multiple criteria before alerting the vehicle user that fuel door 20 is open—e.g., to minimize false alarms or false positive determinations (e.g., thereby avoiding potential user frustration due to false alarms). Thus, in at least one implementation, the processor 84 monitors the status of more than one flag (e.g., such as the flag of step 520). Other criteria are discussed below. Following step 520, the method proceeds to step 525.

It should be appreciated that steps 505, 515, and 520 may be performed in some embodiments, but not in others. For example, in at least one embodiment, the method may begin with step 510 (e.g., receiving one or more real-time images from camera 14) and then proceed to step 525. Also, in yet other embodiments, using the image processing algorithm stored in memory 82, the processor 84 may not compare stored image(s) to real-time image(s), but instead the processor 84 may determine any other suitable criteria associated with the fuel door 20 being in an open state (e.g., using image processing techniques).

In step 525, the processor 84 performs image processing of one or more real-time images. These one or more real-time images may be the same real-time image(s) used in steps 510-515, or different real-time images (e.g., subsequently obtained). In at least one embodiment, they are the same real-time image(s) used in steps 510-515 above. The image processing of step 525 may comprise any suitable technique, including but not limited to, classification techniques, feature extraction techniques, pattern recognition techniques, projection techniques, and the like. In at least one embodiment of step 525, the processor 84 uses an edge detection algorithm. For example, the edge detection algorithm may use feature extraction and/or pattern recognition techniques, among others—e.g., to identify a periphery of the fuel door 20 against a background which is not indicative of the fuel door 20 being in a closed state. For example, the fuel door 20 typically is flush to the body panel 38 of the vehicle 12 when the door is in the closed state (or fully closed). And when the fuel door 20 is at least partially open, the door is typically not flush but instead protrudes outwardly. The outwardly protruding portion may extend within the field of view of the camera 14, enabling its edges to be detected. Thus, the processor 84 may determine an edge by determining a discontinuity in brightness or luminance in the image—e.g., associated with the periphery of the fuel door in contrast to the environment of the vehicle 12 or the vehicle itself (e.g., body panel 38). Of course, this is merely one example; and other analogous implementations are also possible.

In step 530 (FIG. 5B), which follows step 525, the processor 84 may determine whether the results of the image processing technique(s) indicate that the fuel door 20 is open. In at least one embodiment, this determination is based at least partially on an edge detection determination in step 525. When the edge detection algorithm provides an output indicating the fuel door 20 is at least ajar, this may be another criteria suggesting an open state of the fuel door 20. The method may log or record this criteria in step 535 and then proceed to step 540. Alternatively, when the edge detection algorithm determines the fuel door 20 being in the closed state, then the method 500 may proceed directly to step 540.

In step 535, the processor 84 may set a second counter or second flag to a value indicating a criteria that the fuel door 20 is at least partially open (FLAG #2=‘true’)—in response to the edge detection/determination of steps 525 and 530. Thus, in at least one instance, the processor 84 potentially determines two criteria in steps 505-535—the first criteria based on a comparison of a stored image to a real-time image and the second criteria based on an edge detection using the same or a different real-time image.

In step 540, the processor 84 may determine the values of the first and second flags (i.e., FLAG #1 and FLAG #2). If both the first and second flags are ‘true,’ then the method may proceed to step 545 (e.g., sending an alert signal to the vehicle user, as discussed below). Or if the processor determines that only one (or neither) of the flags is ‘true,’ then the method 500 may proceed to step 550 or immediately loop back and repeat at least part of the method (e.g., beginning again with step 510), e.g., to continue to monitor for alert conditions.

In at least one embodiment, any combination of steps 505-540 could be repeated before proceeding further to determine additional criteria. For example, in one embodiment multiple real-time images may be required to match a stored image, and/or multiple processed real-time images may be required to indicate an open fuel door 20 (e.g., using edge detection). Additional flags could be set counting these instances, and the threshold quantity of flags (in step 540) may be higher before the method proceeds to step 545.

In step 545, the processor 84 sends or transmits an output in the form of an alert signal from the ECU 16 to the vehicle electronics 30 in response to the multiple criteria determined to be ‘true’ in step 540. This alert signal may be an electrical signal, an optical signal, short range wireless signal, etc. and may be sent to at least one of the vehicle control modules 36 which in turn provides a suitable alert to the vehicle user (e.g., via the instrument panel 32 and/or audio system 34). Of course, an alert could be sent directly from the ECU 16 (e.g., instead of sending an alert signal to vehicle electronics 30 which then performs the alert). Once received by the instrument panel 32 and/or audio system 34, a visual alert, audible alert, tactile alert, or combination thereof may be provided to the vehicle user. Following step 545, the method 500 may end.

When the method proceeds from step 540 to step 550, the processor 84 may check and/or reset the first and second flags. More specifically, the processor may ensure that both flags have values other than ‘true’ (e.g., ‘none’ or ‘false’). Performing step 550 may be desirable when the system architect of system 10 desires the flags both to be ‘true’ within a prescribed or predetermined period of time of one another (and thus before sending an alert signal from the ECU 16). For example, in at least one embodiment, it may not be desirable to send the alert signal when the edge detection algorithm determines a criteria indicating that the fuel door 20 is open hours or days after an earlier criteria indicated that a real-time image matched a stored image. While not illustrated in FIG. 5B, it is contemplated that the processor 84 could utilize a timer as well—e.g., to only send an alert signal when both flags are ‘true’ within a predetermined time interval. Other suitable implementations are also contemplated herein.

Regardless, following step 550, the method proceeds to step 510 as well. And method 500 may receive one or more subsequent or newer real-time images from camera 14 and continue through at least some of steps 515-550 again. In at least one embodiment, method 500 is periodic. For example, the loop described above in method 500 is not continuously executed. For example, the method 500 may be performed each time the transmission of vehicle 12 moves from PARK to another gear, once per vehicle ignition cycle, etc., just to name a few non-limiting examples. Limiting the repetition of the method 500 may improve an overall performance of the system 10. Recall for example that in at least one embodiment, the system 10 may be used for advanced driver assistance (e.g., lane detection, blind-spot detection, etc.). Thus, it may be desirable to limit the computational demands on processor 84 by only occasionally running or operating method 500—e.g., especially since in at least one embodiment, the primary purpose of the system 10 is not to determine whether the fuel door 20 is ajar, whether the fuel cap 22 is dangling, or whether a nozzle 24 remains in the vehicle 12.

Other implementations are also possible which may be used singly or in combination with method 500. For example, two exemplary criteria were described above which were associated with a region of interest A that includes the fuel door 20 (as shown in FIG. 4). Other criteria also could be determined in regions of interest B and/or C which could indicate an alert condition. As shown in FIG. 4, region of interest B includes a portion of a real-time image that could include the fuel cap 22 (e.g., this includes but is not limited to any region in which the fuel cap 22 may protrude from the vehicle 12 when unattached to port 26; the illustrated region of interest B is below the fuel door 20, as the cap 22 dangles). And region of interest C includes a portion of a real-time image that could include the nozzle 24.

With respect to these other regions of interest (B and C), any portion of the steps of method 500 could be used to determine whether the fuel cap 22 is hanging or dangling or the nozzle 26 is in the vehicle 12. For example, memory 82 may comprise stored image(s) of the fuel cap 22 not dangling below the fuel door 20 and/or stored image(s) of the fuel cap 22 dangling below the fuel door 20—and these images may be compared to real-time image(s) obtained from camera 14. A similar technique may be employed to determine whether the nozzle 24 is present in the vehicle port 26.

In another example, image processing techniques (including using an edge detection algorithm) could be employed to analyze real-time image(s) and detect whether the fuel cap 22 is or is not dangling below the fuel door 20. Again, a similar technique could be employed to determine whether the nozzle 24 is or is not present in the vehicle port 26. Regardless of how the fuel cap 22 or nozzle 24 may be detected or determined, the processor 84 may presume that if the cap 22 is dangling or the nozzle is in the port 26, then the fuel door 20 is open; thus, in at least one embodiment, the processor 84 may send the alert signal, even if step 540 of method 500 did not determine both the first and second flags were ‘true.’

Thus, the processor 84 may determine other criteria—e.g. associated with these other regions of interest B, C (e.g., a third flag, a fourth flag, etc.). Further, the processor 84 may determine whether to issue the alert signal from the ECU 16 based upon more than two flags being ‘true’ (or different combinations of the flags being ‘true’).

In at least one embodiment, processor 84 determines that the fuel nozzle 24 is located in region of interest C and that the vehicle 12 has been shifted from PARK (e.g., to DRIVE, REVERSE, NEUTRAL, etc.). In this instance, the processor 84 promptly transmits an alert signal (e.g., to the vehicle electronics 30) to warn the driver that the vehicle 12 is pulling away from a filling station with the nozzle 24 engaged with the fuel port 26. While more than one criteria may be used, in at least one implementation, a single criteria is needed to trigger this alert signal—namely, identification of the nozzle 24 in region of interest C.

In some embodiments, a different alert signal may be used—e.g., alert signals which are not used by the vehicle 12 to cause visual, audible, or tactile alerts, but instead an alert signal which operates an emergency inhibit function. For example, when the vehicle 12 changes gears (e.g., from PARK to any other gear) and the nozzle 24 has been determined to be within the port 26, the alert signal may be sent to a VCM 36 which controls the vehicle drive train. In one embodiment, a VCM 36 may cause the vehicle 12 to brake automatically—e.g. inhibiting the vehicle 12 from moving away from the filling station with the nozzle 24 within the port 26.

Other implementations include requiring all criteria to be determined as ‘true’ simultaneously or otherwise be in a ‘true’ state at the same time. The order of determining criteria could be changed; e.g., in method 500, steps 510-520 could occur after steps 525-535, or the like.

In another implementation, ECU 16 may require other additional criteria that the fuel door 20 is open prior to sending the alert signal. For example, one of the VCMs 36 in the vehicle 12 may determine a low fuel tank pressure condition and provide an informational message to the ECU 16 regarding the low pressure condition. And this criteria (from VCM 36), combined with criteria determined using image data from the camera 14, may trigger the ECU 16 to send the alert signal. For example, the processor 84 may send an alert signal based on this VCM 36 criteria and criteria associated with region of interest B (e.g., that the fuel cap 22 is dangling).

Thus, there has been described an optical sensing system which can be used to determine a fuel door status—e.g., whether a fuel door alert condition exists. For example, an alert condition may include determining that a vehicle fuel door is open, determining that a vehicle fuel cap is dangling, and/or determining that a fuel station filling nozzle remains in a vehicle (e.g., just prior to the vehicle driving away from the filling station). The system may include an electronic control unit (ECU) and one or more sensors. To determine the fuel door status, the ECU may employ image processing techniques (e.g., comparing stored images to real-time images from the sensors, using real-time edge detection techniques, etc.). When the ECU determines that the fuel door is at least partially open, the ECU may provide an alert signal which may be used to notify a user of the vehicle of the condition.

It should be understood that all references to direction and position, unless otherwise indicated, refer to the orientation of the parking brake actuator illustrated in the drawings. In general, up or upward generally refers to an upward direction within the plane of the paper and down or downward generally refers to a downward direction within the plane of the paper.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A system to detect a vehicle fuel door alert condition, comprising:
an optical sensor having a field of view (FOV) which includes a vehicle fuel door region, the optical sensor providing an output including image data associated with the fuel door region; and
a controller in communication with the optical sensor to receive the output, the controller including at least one processor adapted to analyze the optical sensor output and provide an alert output at least when the optical sensor output is indicative that a fuel door in the vehicle fuel door region is at least partially open.

2. The system of claim 1, wherein the optical sensor is a camera.

3. The system of claim 1, wherein the controller further comprises a non-transitory computer readable memory having instructions stored thereon for determining the vehicle fuel door alert condition and, when the alert condition is determined, providing the alert output from the controller to vehicle electronics, wherein the instructions comprise:
receiving an image from the optical sensor comprising a region of interest that includes the fuel door region;
using the image and a pattern recognition technique to determine whether the fuel door is at least partially open; and
when an image processing result using the pattern recognition technique indicates that the fuel door is at least partially open, then providing the alert output.

4. The system of claim 1, wherein the at least one processor is adapted to analyze the optical sensor output and provide the alert output at least when the optical sensor output is indicative of a vehicle fuel cap not being secured to a vehicle fuel fill port or a filling station fuel nozzle being within the fuel fill port.

5. The system of claim 1, wherein, prior to providing the alert output, the controller is adapted to determine multiple criteria indicating that the fuel door is at least partially open.

6. The system of claim 1, wherein the controller is adapted to provide the alert output without image processing of additional image data, when the controller: analyzes the optical sensor output, determines that the optical sensor output is indicative of a filling station nozzle being located within a fuel fill port of a vehicle, and receives an indication from vehicle electronics that a transmission of the vehicle is not in PARK.

7. The system of claim 1, further comprising a plurality of optical sensors in communication with the controller, wherein the controller is adapted to provide advance driver assistance services using sensor output from the plurality of optical sensors.

8. A system to detect a vehicle fuel door alert condition, comprising:
an optical sensor adapted to monitor an area that includes a vehicle fuel door region; and
a controller that is couplable to the optical sensor, the controller comprising memory and at least one processor, wherein the memory is a non-transitory computer readable medium having instructions stored thereon for determining the vehicle fuel door alert condition, wherein the instructions comprise:
receiving an image from the optical sensor comprising a region of interest that includes the fuel door region;
analyzing the image using image processing techniques to determine at least one criteria associated with the alert condition; and
when the at least one criteria is determined, then providing the alert signal.

9. The system of claim 8, wherein the instructions further comprise: analyzing the image using image processing techniques to determine two or more criteria associated with the alert condition, and providing the alert signal when the two or more criteria are determined.

10. The system of claim 8, wherein the alert condition is associated with: an indication that a vehicle fuel door is at least partially open, an indication that a vehicle fuel cap is not secured, an indication that a filling station fuel nozzle is located within a fuel port of the vehicle, or a combination thereof.

11. The system of claim 8, wherein the optical sensor is a camera.

12. The system of claim 8, further comprising a plurality of optical sensors in communication with the controller, wherein the controller is adapted to provide advance driver assistance services using sensor output from the plurality of optical sensors.

13. A method of detecting a vehicle fuel door alert condition using a controller in a vehicle, comprising the steps of:
receiving at the controller at least one image from an optical sensor, wherein the at least one image comprises a region of interest associated with a vehicle fuel door region;
using the at least one image, determining at the controller whether the vehicle fuel door alert condition exists, wherein the alert condition is associated with a fuel door in the vehicle fuel door region being at least partially open; and
when the alert condition is determined to exist, then providing an alert signal from the controller.

14. The method of claim 13, wherein determining whether the alert condition exists comprises at least one of the following:
determining an indication that a vehicle fuel door is at least partially open using the at least one image,
determining an indication that a vehicle fuel cap is not secured using the at least one image, or
determining an indication that a filling station fuel nozzle is located within a fuel port of the vehicle using the at least one image.

15. The method of claim 13, wherein determining whether the alert condition exists further comprises determining multiple criteria indicative of the alert condition using the at least one image.

16. The method of claim 13, wherein determining whether the alert condition exists further comprises using a pattern recognition technique, a feature extraction technique, or both to determine a criteria indicative of the alert condition.

17. The method of claim 13, wherein determining whether the alert condition exists further comprises: comparing a stored image to the at least one image, using an edge detection image processing technique on the at least one image, or both.

18. The method of claim 13, wherein determining whether the alert condition exists further comprises:
using the at least one image, determining that a filling station fuel nozzle is located within a fuel port of the vehicle;
receiving an indication from a vehicle control module (VCM) that the vehicle transmission is no longer in PARK; and
based on the received indication and the determination that the fuel nozzle is located in within the fuel port, providing the alert signal.

19. The method of claim 13, wherein determining whether the alert condition exists is initiated when the vehicle is stationary.
